(19) United States
(12) Patent Application Publication
(10) Pub. No.: US 2020/0196645 A1
(43) Pub. Date: Jun. 25, 2020

(54) PROCESS FOR THE PRODUCTION OF A SAUCE CONTAINING MEAT

(71) Applicant: Barilla G. e R. Fratelli S.p.A., Parma (IT)

(72) Inventors: Vincenzo De Tata, Parma (IT); Marcella Ponanti, Parma (IT); Fabio Bettega, Salsomaggiore Terme (Parma) (IT); Andrea Spotti, Fidenza (Parma) (IT); Roberto Alberti, Parma (IT)

(73) Assignee: Barilla G. e R. Fratelli S.p.A., Parma (IT)

(21) Appl. No.: 16/704,329

(22) Filed: Dec. 5, 2019

(30) Foreign Application Priority Data
Dec. 21, 2018 (IT) 102018000020899

(51) Int. Cl. A23L 13/40; A23J 3/22

(52) U.S. Cl. CPC A23L 13/426; A23L 23/00; A23L 13/428; A23J 3/227

(57) ABSTRACT

A process for the production of a sauce containing minced meat, tomato, vegetables, edible oils or fats and optional complementary ingredients is disclosed. The process includes the steps of a) of subjecting pellets of a mixture containing minced meat to baking in an oven, obtaining baked pellets, b) adding, in a cooker, the baked pellets to tomato, vegetables, edible oils or fats and optional complementary ingredients, and c) cooking the whole mixture for a predetermined time.

### CROSS-REFERENCE TO RELATED APPLICATIONS

This application claims the benefit of priority from Italian patent application No. 102018000020899 filed on Dec. 21, 2018, the contents of which are incorporated herein by reference.

### FIELD OF APPLICATION

The present invention relates to the technical sector of the food industry. In particular, the invention relates to a process for the production of a sauce containing meat, such as a meat raga.

### PRIOR ART

Raga is one of the most popular sauces in Italian and international cuisine and is typically used as a condiment for first courses. It is known that the preparation of this sauce is somewhat laborious and requires a long time for cooking of the minced meat (usually beef and pork) and the chosen vegetables, in order to develop the characteristic flavors and aromas and obtain a pleasing consistency of the minced meat when tasted.

According to the traditional recipe of raga, the meat is characterized by a certain granular consistency and the particles of minced meat, although homogeneously integrated in the sauce, can still be tasted in the mouth following cooking, because of their characteristic consistency.

Precisely because of the long time required for preparation of the raga, the consumer is often induced to buy industrially prepared ready-to-use sauces, which may be sterilized sauces packaged in tins or glass jars and able to be stored at room temperature, or packaged pasteurized sauces which are stored at refrigerator temperature, or finally deep-frozen sauces, which have also undergone a pasteurization process.

However, the consistency of the commercially made ready-to-use ragú sauces does not always satisfy fully the consumer, because they are often in the form of a homogeneous mixture of minced meat, spices, vegetables and tomato sauce, in which the particles of minced meat cannot always be perceived by the taste buds. This is due to the fact that the procedures conventionally employed for the industrial preparation of meat-based sauces involve a reduction in the size of the minced meat particles.

The aforementioned conventional procedures consist essentially in a repetition of the operations performed on a small scale, but in much more strictly controlled operating conditions, in order to ensure optimum microbiological properties of the finished product. According to these procedures, the minced meat is added to a fried mixture of vegetables and/or edible oils inside a large cooker provided with mixing means, followed by the addition of a tomato sauce and any further ingredients, such as flavorings and spices.

The ratio between the volume of the cooker and the heating surface is such that only the meat in contact with the walls of the cooker undergoes a real browning process, while the remaining part is “simmered”. Moreover, in order to prevent burning against the hot walls, the meat is continuously mixed, being subject to a mechanical stress which reduces the size of the meat particles, with the result that in the final sauce the meat is in the form of minute particles, which cannot be easily perceived when eaten and moreover has a “dry” consistency in terms of taste.

The problem underlying the present invention is that of providing a meat-based sauce, in particular a raga, which is ready-to-use and where the particle size of the minced meat is such that the particles of cooked meat may be perceived when eaten by the consumer.

### SUMMARY OF THE INVENTION

The problem has been solved by providing a process for the production of a sauce comprising minced meat, tomato, vegetables, edible oils or fats and optional complementary ingredients, wherein the process comprises:
a step a) of subjecting pellets of a mixture comprising minced meat to baking in a conduction and convection oven, at a temperature of between 160° C. and 280° C., for a time of between 0.5 and 30 minutes, thus obtaining baked pellets,
a step b) of adding, in a cooker, said baked pellets to said tomato, vegetables, oils or edible oils or fats and optional complementary ingredients and
a step c) of cooking the whole mixture for a predetermined time.

The term “complementary ingredients” is understood as meaning the ingredients which complement the recipe in which the product according to the present invention is used. These complementary ingredients serve to give flavor to the meat-based sauce according to the invention and comprise for example salt, pepper, sugar and aromatic herbs including rosemary, sage, mint, oregano, parsley, thyme, bay leaf, cloves, basil, chives, marjoram, nutmeg and coriander.

The aforementioned vegetables are obviously different from tomato and are preferably chosen from the group comprising onion, shallot, leek, carrot, celery, garlic and parsley.

Preferably, these vegetables are minced and have a particle size of between 3 mm and 20 mm, more preferably between 5 mm and 10 mm.

Preferably the aforementioned mixture pellets comprising minced meat have a length of between 10 mm and 70 mm, more preferably between 30 mm and 40 mm, and a thickness of between 3 and 15 mm.

Preferably, said pellets comprise, in addition to meat, at least one complementary ingredient selected from the group comprising salt, sugar, starch, fiber, pepper, aromatic herbs including rosemary, sage, mint, oregano, parsley, thyme, bay leaf, cloves, basil, chives, marjoram, nutmeg and coriander and optionally tomato and/or at least one of said vegetables including onion, shallot, leek, carrots, celery and garlic.

The aforementioned edible oils or fats are preferably selected from the group comprising olive oil (in particular, extra virgin olive oil), sunflower oil, peanut oil, soya oil, rapeseed oil, corn oil and butter,

Preferably, in the aforementioned step a), the aforementioned pellets are arranged on a conveyor belt and the oven is a tunnel oven inside which the conveyor belt runs.

Preferably, said conveyor belt is heated to a temperature of 160°−280° C., advantageously 220°−260° C.

The temperature inside the tunnel oven is preferably between 180° C. and 280° C., advantageously between 220° C. and 260° C., and in the tunnel oven, means for injecting jets of steam and hot air (at a temperature of 200°−300° C., preferably 230° C.−280° C.) are provided.

The mixture pellets comprising minced meat may be produced by extruding a mixture comprising minced meat and optionally one or more complementary ingredients as defined above and/or tomato and/or one or more vegetables as defined above, by means of an extruder provided with a cutter which divides the mixture output from the extruder into pellets having a length of between 10 mm and 70 mm, preferably between 30 mm and 40 mm, and a thickness of between 3 and 15 mm.

The pellets thus produced are dropped onto a conveyor belt of a tunnel oven and conveyed away to the aforementioned baking step a) in an oven.

Preferably, upon leaving the oven, the pellets are dropped onto a second conveyor belt which conveys them to a disaggregation apparatus to free the individual pellets from any clumps formed during baking.

The pellets following baking in an oven generally have a length of between 5 and 60 mm, preferably between 7 and 30 mm.

Upon leaving the oven, the baked pellets fall onto a grille where they are drained, with removal of the residual liquid component from the baking oven.

The pellets are then dropped onto a conveyor belt which conveys them inside a vertical hopper. Here, once they have fallen, the pellets enter a disaggregation apparatus, in technical jargon also called a “delumper” or “lump breaker”, which reduces to a smaller size any lumps which may have formed during baking in the oven.

The pellets thus obtained are finally conveyed to step b), introducing them into a cooker which is provided with mixing means and inside which are there already vegetables and optionally the complementary ingredients fried beforehand in an edible oil or fat as well as the tomato (in the form of pulp or puree and/or concentrate) which is then added to the fried mixture.

After optionally adding one or more complementary ingredients, the whole mixture is kept at a temperature of between 70 and 100° C. while continuously mixing, for a time of between 15 and 120 minutes.

The minced meat used for the process according to the invention may be bovine, pork, ovine, horse, poultry or fish meat. Preferably, it consists of bovine or pork meat or both.

The minced meat used for the preparation of the pellets employed in the process according to the invention is obtained from blocks of meat which are subjected to grinding in a meat mincer resulting in minced meat with a particle size of between 6 and 20 mm.

The minced meat thus obtained then optionally has added thereto one or more complementary ingredients selected from the group comprising salt, sugar, starch, fiber, pepper and aromatic herbs including rosemary, sage, mint, oregano, parsley, thyme, bay leaf, cloves, basil, chives, marjoram, nutmeg and coriander, and/or tomato and/or one or more vegetables selected from onion, shallot, leek, carrots, celery and garlic, and is mixed with them in a mixer for a few (1-10) minutes, and the mixture thus obtained is then fed to a subsequent meat mincer, so as to obtain particles of minced meat mixture with a size of 3-10 mm, which are finally conveyed to the extruder described further above to form the aforementioned pellets of minced meat mixture.

Oven baking of the pellets of minced meat mixture is performed without subjecting the pellets to any mechanical stress, unlike that which happens in the conventional process which involves the browning of the minced meat in a cooker provided with mixing means and therefore results in a reduction in the size of the meat particles and loss of consistency thereof. In the process according to the present invention, instead, baking in an oven without mechanical stress preserves the size of the pellets and their consistency.

The above has been confirmed experimentally by means of comparative tests carried on meat ragú prepared using identical recipes (same ingredients in the same amounts) on the one hand using the conventional process described further above and on the other hand using the process according to the present invention. The tasters used for these comparative tests have confirmed that the ragú obtained with the process according to the present invention had a taste of browned meat which was much rounder and more intense and in particular was such that the consistency of the minced meat particles could be much more distinctly perceived by the taste buds.

### DETAILED DESCRIPTION OF A PREFERRED EMBODIMENT

The process according to the present invention will be further described with reference to an example of application provided hereinbelow by way of non-limiting illustration.

### EXAMPLE

Ragú Bolognese

Blocks of bovine meat (front quarter cuts) and pork (frozen shoulder), kept stored in a cold room at −20° C., were used for the production of ragú bolognese using the process according to the present invention.

These blocks of meat were defrosted in a radiofrequency (RF) tunnel for about 40 minutes. The blocks of defrosted meat were then fed to the hopper of a first meat mincer, producing minced meat with particles having a size of about 13 mm.

The minced meat thus obtained (300 kg) was fed into a mixer and 3.5 kg of salt were added thereto. After mixing for two minutes at a speed of 0.6 rpm, the mixture thus obtained was fed to the hopper of a second meat mincer, which reduced the size of the pellets in sequence first to 7.8 mm and then to 4 mm.

Thereafter the mixture was conveyed to an extruder with holes having a size of 4×4 mm, provided with a cutter, which divided the strings of mixture into pellets with a thickness of about 4 mm, a length of about 36 mm and a weight of about 0.6 g.

These pellets were dropped onto a conveyor belt heated to a temperature of 260° C. and conveyed by the latter inside a convection tunnel oven (air temperature 280° C.). After remaining inside the tunnel oven for about 2 minutes, the baked pellets leaving the oven were transferred onto a second conveyor belt, where they were drained, namely the baked pellets were separated from the liquid generated during baking.

The aforementioned second conveyor belt then conveyed the baked and drained pellets to the aforementioned disaggregation apparatus where the single pellets were separated from any lumps which may have formed during baking.

The baked pellets had a length of about 11-13 mm, a thickness of about 5-7 mm and a weight of about 0.17 g.

The following ingredients were introduced inside a cooker provided with a horizontal-paddle mixer:

| | |
|---|---|
| Sunflower oil | 70 kg |
| Chopped onions | 250 kg |
| Chopped carrots | 105 kg |
| Chopped celery | 110 kg |

The chopped onions, carrots and celery had a particle size of about 4-10 mm.

After cooking the aforementioned ingredients at boiling temperature for 27 minutes with continuous mixing, the following ingredients were introduced into the cooker:

| | | |
|---|---|---|
| Tomato | 900 | kg |
| Cooked meat pellet | 550 | kg |
| Salt | 19 | kg |
| Sugar | 14 | kg |
| Aromatic herbs and spices | 3 | kg |

Thereafter (after about 20 minutes) the following premixed ingredients were added:

| | |
|---|---|
| Corn starch | 25 kg |
| Yeast extract | 10 kg |

Finally (immediately following the addition of starch and yeast) a second amount of tomato (400 kg) was added and heated for 30 minutes.

The meat ragú thus obtained was heated to a temperature of 90-95° C. and filled into 400 g glass jars and these were finally sterilized in an autoclave with F0=8 minutes (TBC).

### Comparative Example

A ragú bolognese was prepared using the same ingredients used in the preceding example and in the same amounts, with the difference that the minced meat (350 kg) obtained at the outlet of the first meat mincer was introduced, together with the salt (3.5 kg), into a first cooker provided with horizontal-paddle mixer and cooked for about 30 minutes with continuous mixing.

At the end of cooking, the meat was transferred into a second cooker provided with a horizontal-paddle mixer inside which the chopped onions, the chopped carrots and the chopped celery had already been browned in sunflower oil in the amounts and using the methods described in the preceding example. Tomato, salt, sugar, aromatic herbs and spaces were also introduced into the cooker in the same amounts as in the preceding example, after about 20 minutes corn starch and yeast extract were added in the same amounts as in the preceding example, followed immediately thereafter by the same amount of tomato as in the preceding example, and cooking performed for a further 30 minutes.

The meat ragú thus obtained was then heated to a temperature of 90-95° C. and filled into 400 g glass jars which were finally sterilized in an autoclave with F0=8 minutes.

The ragú prepared according to the example of the present invention was subjected to a tasting test for comparison with the raga prepared according to the comparative example.

The two ragú preparations were tasted by 160 consumers of meat sauces who were asked to rate on a scale from 0 to 9 the organoleptic and structural characteristics of the two ragú sauces, with particular reference to the consistency, taste and appearance of the meat.

A significant preference was expressed for the ragú prepared according to the example of the present invention, with the following ratings:

| | Ragù according to | Ragù according to the |
|---|---|---|
| Characteristics | the invention | comparative example |
| Overall impression | 6.1 | 5.3 |
| Appearance | 6.5 | 6.1 |
| Consistency of the sauce | 6.4 | 5.5 |
| Consistency of the meat | 6.1 | 5.5 |
| Flavor of the meat | 5.9 | 5.1 |

1. A process for the production of a sauce comprising minced meat, tomato, vegetables, edible oils or fats and optional complementary ingredients, comprising:
a) subjecting pellets of a mixture comprising minced meat to baking in a conduction and convection oven, at a temperature of between 160° C. and 280° C., for a time of between 0.5 and 30 minutes, thus obtaining baked pellets,
b) adding, in a cooker, said baked pellets to said tomato, vegetables, edible oils or fats and optional complementary ingredients; and
c) cooking the whole mixture for a predetermined time.

2. The process according to claim 1, wherein said complementary ingredients are selected from the group consisting of salt, pepper, sugar and aromatic herbs, including rosemary, sage, mint, oregano, parsley, thyme, bay leaf, cloves, basil, chives, marjoram, nutmeg and coriander.

3. The process according to claim 1, wherein said vegetables are selected from the group consisting of onion, shallot, carrot, celery, leek, garlic and parsley.

4. The process according to claim 3, wherein said vegetables are minced and have a particle size of between 3 mm and 20 mm.

5. The process according to claim 1, wherein said pellets to be baked in the oven of step a) have a length of between 10 mm and 70 mm, and a thickness of between 3 mm and 15 mm.

6. The process according to claim 5, wherein said mixture pellets further comprise at least one complementary ingredient selected from the group consisting of salt, sugar, starch, fiber, pepper, aromatic herbs including rosemary, sage, mint, oregano, parsley, thyme, bay leaf, cloves, basil, chives, marjoram, nutmeg and coriander, and/or tomato and/or at least one vegetable selected from the group consisting of onion, shallot, leek, carrots, celery and garlic.

7. The process according to claim 1, wherein, in step a), said pellets are arranged on a conveyor belt and the oven is a tunnel oven inside which the conveyor belt runs.

8. The process according to claim 7, wherein said conveyor belt is heated to a temperature of 160° C.-280° C.

9. The process according to claim 8, wherein the temperature inside said tunnel oven is between 180° C. and 280° C.

10. The process according to claim 9, wherein means for injecting jets of steam and hot air having a temperature of 200° C.-300° C. are provided in said tunnel oven.

11. The process according to claim 7, wherein said mixture pellets are produced by extruding a mixture comprising minced meat and optionally one or more complementary ingredients selected from the group consisting of salt, sugar, starch, fiber, pepper, aromatic herbs including rosemary, sage, mint, oregano, parsley, thyme, bay leaf, cloves, basil, chives, marjoram, nutmeg and coriander and/or tomato and/or one or more vegetables selected from the group consisting of onion, shallot, leek, carrots, celery and garlic, by means of an extruder provided with a cutter which divides the mixture output from the extruder in the form of a string into pellets having a length of between 10 mm and 70 mm, and a thickness of between 3 and 15 mm.

12. The process according to claim 7, wherein upon leaving the oven said pellets are dropped onto a second conveyor belt, which conveys them to a disaggregation apparatus to free individual pellets from any clumps formed during baking.

13. The process according to claim 1, wherein, following baking, said pellets have a length of between 5 and 60 mm.

14. The process according to claim 1, wherein in step b) said cooker is provided with mixing means and said pellets are introduced into said cooker already containing inside it a fried mixture obtained from said vegetables, from the optional complementary ingredients and from said edible oils or fats, as well as the tomato, which was subsequently added to said fried mixture.

15. The process according to claim 1, wherein said predetermined time of the cooking step c) is between 15 and 120 minutes.

16. The process according to claim 1, wherein said minced meat is selected from the group consisting of bovine, pork, ovine, horse, poultry and fish meat.

17. The process according to claim 16, wherein said minced meat consists of bovine meat, pork meat or a mixture thereof.
